(19) United States
(12) Patent Application Publication
(10) Pub. No.: US 2022/0172378 A1
(43) Pub. Date: Jun. 2, 2022

(54) IMAGE PROCESSING APPARATUS, IMAGE PROCESSING METHOD AND NON-TRANSITORY COMPUTER READABLE MEDIUM

(71) Applicant: NEC Corporation, Minato-ku, Tokyo (JP)

(72) Inventors: Shreya SHARMA, Tokyo (JP); Masato TODA, Tokyo (JP)

(73) Assignee: NEC Corporation, Minato-ku, Tokyo (JP)

(21) Appl. No.: 17/600,288

(22) PCT Filed: Apr. 3, 2019
(86) PCT No.: PCT/JP2019/014832

§ 371 Date: Sep. 30, 2021

(51) Int. Cl. G06T 7/246

(52) U.S. Cl. CPC G06T 7/248; G06T 2207/20084; G06T 2207/20081; G06T 2207/20076

(57) ABSTRACT

An object is to provide an image processing apparatus capable of appropriately detecting changes of a target object. An image processing apparatus may include: object-driven feature extractor means to extract relevant features of target object from input images; a feature merger means to merge the features extracted from the input images into a merged feature; a change classifier means to predict a probability of each change class based on the merged feature; an object classifier means to predict a probability of each object class based on the extracted features of each image; a multi-loss calculator means to calculate a combined loss from a change classification loss and an object classification loss; and a parameter updater means to update the parameters of the object-driven feature extractor means.

### TECHNICAL FIELD

The present disclosure relates to an image processing apparatus, image processing method and image processing program.

### BACKGROUND ART

Change detection is a widely researched topic in remote sensing and is considered an important preliminary analysis before any advanced analysis such as object recognition. Given a pair of images, it aims to infer changes which have occurred between the pair of images over a period of time. With the advent of very high resolution sensors, it has become possible to capture changes due to small objects such as cars, human and containers. Change detection of such small objects is of interest because it helps in effective monitoring of crowded and dynamic areas. Synthetic Aperture Radar (SAR) is an ideal source for monitoring such areas because of its ability to capture images even under bad weather and no-sunlight conditions.

Traditional methods of change detection employ a pixel-to-pixel based difference between images in which each pixel of the first image is compared to the corresponding pixel of the second image. These methods, however, do not work well in very high resolution SAR images because the pixel is sensitive to SAR artifacts (shadow, layover and speckle noise) and may show a change even if there is no semantic meaning of that change. To tackle this, feature-to-feature based difference has been proposed where the features of the target object are manually modelled using domain knowledge. Such a method is disclosed in NPL1. A filter to extract features is applied directly to the images, and the two results are compared to detect the changes due to the object. However, the method has less industrial applicability because the manual features require domain knowledge and are not robust to changes in object orientation and noise.

Neural-networks can automatically extract features of an object robust to changes in orientation and noise. One type of neural networks, called siamese network, is well suited for the task of change detection because it can receive the input of a pair of images to extract features and then output a change class for each pixel. A related art of employing the siamese network for change detection is disclosed in PL 1 and shown in FIG. 11. The network includes three main steps: feature extraction, feature merging and classification. First, each branch (feature extractor unit) receives the input of an image and extracts features. Second, the features are merged in the feature merger unit through concatenation to obtain a merged feature representation. Third, a classifier is trained with the extracted features and assigns each pixel a probability of belonging to a change class. While training the network, a loss is computed between the predicted change class and the true change class, and this loss is back-propagated to the feature extraction step and the classification step until the network converges to a state in which the loss cannot be reduced further. At this state, the network is considered trained and can be used in operation.

### CITATION LIST

### Patent Literature

PL 1: CN108573276A

### Non-Patent Literature

NPL 1: Francesca Bovolo, Carlo Marin, and Lorenzo Bruzzone. “A hierarchical approach to change detection in very high resolution SAR images for surveillance applications.” IEEE Transactions on Geoscience and Remote Sensing 51.4 (2013): 2042-2054.

### SUMMARY OF INVENTION

### Technical Problem

Although, the neural-network disclosed in PL 1 can extract robust features for different objects automatically, it cannot detect the changes of the target object with high accuracy. For example, in a pair of images if there are multiple objects such as cars, humans and asphalt road, and if the user is interested in changes caused by the movement of cars only, the related art cannot distinguish those changes from changes due to human or asphalt road conditions.

This is because in the feature extraction process of the related art, the network learns features of all the objects simultaneously. Even though the network is trained with change labels of only the target object, the SAR images are so noisy and less in number that it becomes difficult for the network to differentiate between relevant and irrelevant features solely based on the change labels. As a result, the related art cannot perform well in change detection task of the target object.

The present invention has been made to solve the above mentioned problems and the objective thereof is to provide an image processing apparatus, image processing method and image processing program capable of appropriately detecting changes of a target object.

### Solution to Problem

In the first example aspect, an image processing apparatus including:

an object-driven feature extractor means to extract relevant features of target object from input images;

a feature merger means to merge the features extracted from the input images into a merged feature;

a change classifier means to predict a probability of each change class based on the merged feature;

an object classifier means to predict a probability of each object class based on the extracted features of each image;

a multi-loss calculator means to calculate a combined loss from a change classification loss and an object classification loss; and

a parameter updater means to update parameters of the object-driven feature extractor.

In the second example aspect, an image processing method including:

extracting object-driven features of target object from input images;

merging the features extracted from the input images into a merged feature;

predicting a probability of each change class based on the merged feature;

predicting a probability of each object class based on the extracted features of each image;

calculating a combined loss from a change classification loss and an object classification loss; and

updating parameters for extracting the object-driven feature.

In a third example aspect, a non-transitory computer readable medium storing an image processing program is a non-transitory computer readable medium storing an image processing program for causing a computer to execute an image processing method, the image processing method including:

extracting object-driven features of target object from input images;

merging the features extracted from the input images into a merged feature;

predicting a probability of each change class based on the merged feature;

predicting a probability of each object class based on the extracted features of each image;

calculating a combined loss from a change classification loss and an object classification loss; and

updating parameters for extracting the object-driven feature.

### Advantageous Effects of Invention

According to the present disclosure, it is possible to provide an image-processing apparatus, an image processing method and an image processing program capable of appropriately classifying the changes of the target object in two or more SAR images with high accuracy.

### BRIEF DESCRIPTION OF DRAWINGS

FIG. 1 is a depiction showing the problem formulation of change detection;

FIG. 2 is a block diagram showing a configuration example of an image processing apparatus according to the first embodiment in a training mode;

FIG. 3 is a flowchart showing an example of an operation performed by the image processing apparatus according to the first embodiment in the training mode;

FIG. 4 is a block diagram showing a configuration example of an image processing apparatus according to the first embodiment in an operational mode;

FIG. 5 is a flowchart showing an example of an operation performed by the image processing apparatus according to the first embodiment in the operational mode;

FIG. 6 is a block diagram showing a configuration example of an image processing apparatus according to the second embodiment;

FIG. 7 is a flowchart showing an example of an operation performed by the image processing apparatus according to the second embodiment;

FIG. 8 is a block diagram showing a configuration example of an image processing apparatus according to the third embodiment;

FIG. 9 is a flowchart showing an example of an operation performed by the image processing apparatus according to the third embodiment;

FIG. 10 is a depiction showing the exemplary configurations of object-driven feature extraction units; and

FIG. 11 is a block diagram showing a method described in PL1.

### DESCRIPTION OF EMBODIMENTS

Embodiments of the present disclosure are explained in detail with reference to the drawings. The same components are denoted by the same symbols throughout the drawings, and duplicated explanations are omitted as necessary for clarifying the explanations.

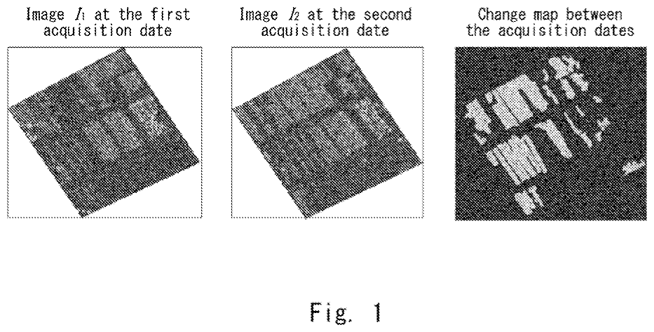

Prior to explaining embodiments, a change detection problem will be explained with reference to FIG. 1. Given two multi-temporal SAR images I₁ and I₂ of same area as shown in the FIG. 1, the objective of change detection is to generate a change map, representing changes of the target objects that have occurred between the acquisition dates of the two images. It is to be noted that the present disclosure is not limited to binary change detection and also includes multiple change detection.

### First Embodiment

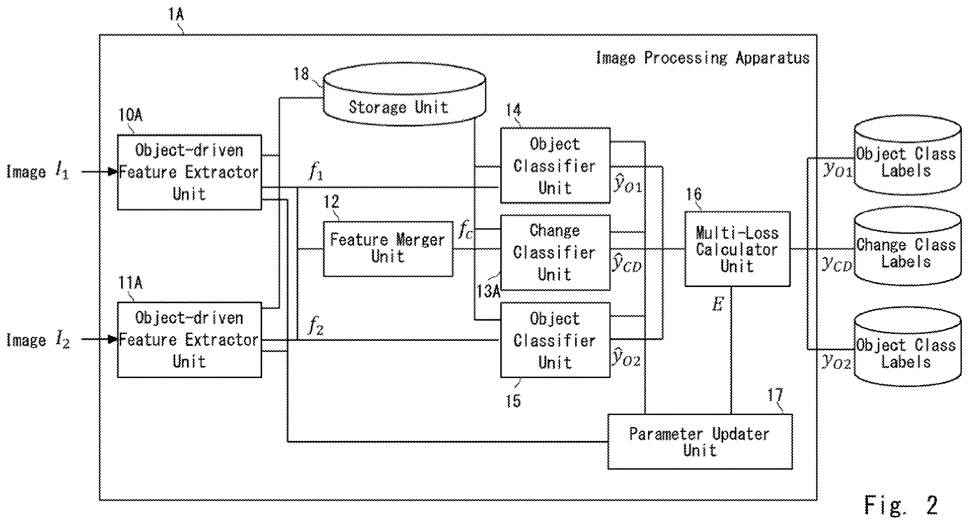

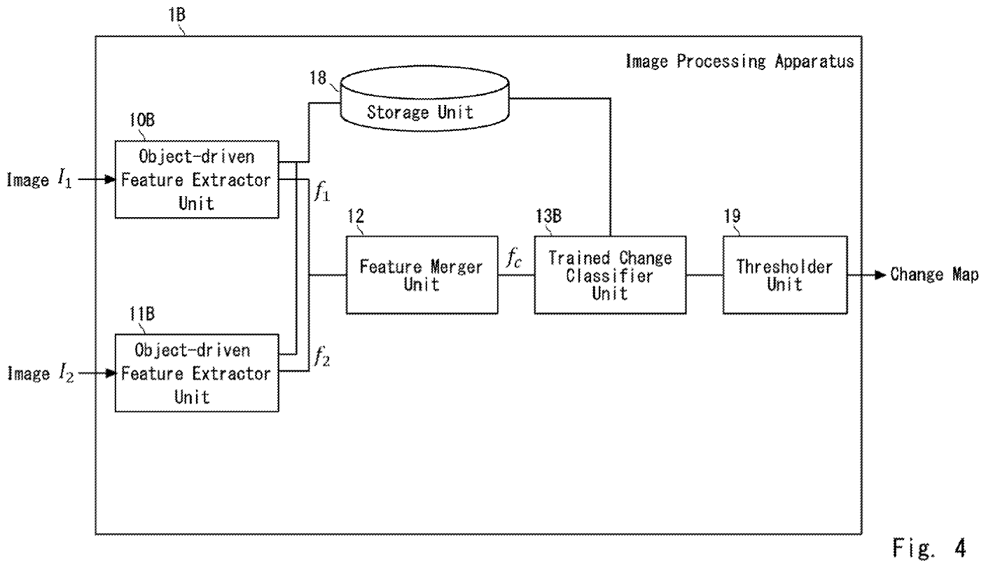

A configuration example of an image processing apparatus in accordance with the first embodiment of the present disclosure will be explained with reference to block diagrams shown in FIG. 2 and FIG. 4. The image processing apparatus in accordance with the first embodiment works in two modes—a training mode (image processing apparatus 1A) and an operational mode (image processing apparatus 1B).

In the training mode as shown in FIG. 2, the image processing apparatus 1A can include an object-driven feature extractor unit 10A for image I₁, an object-driven feature extractor unit 11A for image I₂, a feature merger unit 12, a change classifier unit 13A, an object classifier unit 14 for image I₁, an object classifier unit 15 for image I₂, a multi-loss calculator unit 16, a parameter updater unit 17 and a storage unit 18.

In the operational mode as shown in FIG. 4, the image processing apparatus 1B can include the trained object-driven feature extractor unit 10B for image I₁, the trained object-driven feature extractor unit 11B for image I₂, the storage unit 18, the feature merger unit 12, a trained classifier unit 13B and a thresholder unit 19.

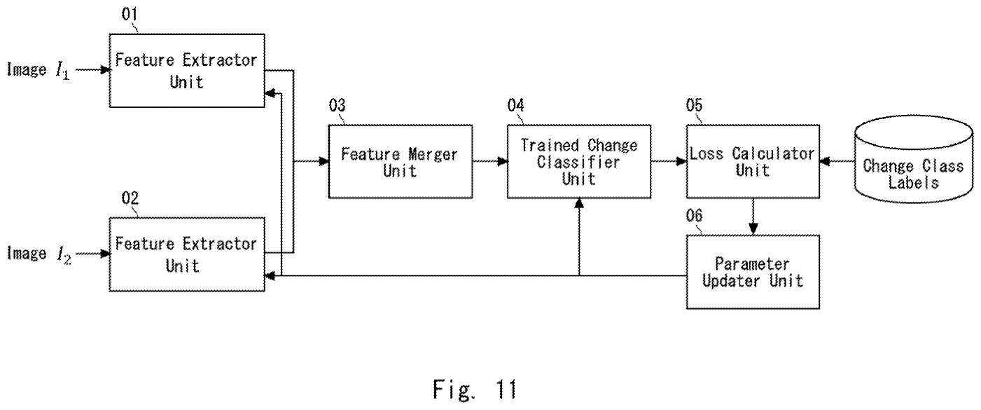

As compared to the related art shown in FIG. 11, the image processing apparatus in accordance with the first embodiment can include an object-driven feature extractor unit 10 for image I₁, an object-driven feature extractor unit 11 for image I₂, an object classifier unit 14 for image I₁, an object classifier unit 15 for image I₂ and a multi-loss calculator unit 16. Object-driven feature extractor units 10 and 11 can extract features specific to a target object from the images I₁ and I₂, respectively. Object classifier units 14 and 15 can classify the pixels in the image I₁ and I₂, respectively into two classes, object or no-object, respectively. Multi-loss calculator unit 16 can calculate a combined loss function from a change classification loss and an object classification loss. Next, functioning of these units along with the other units will be explained in detail.

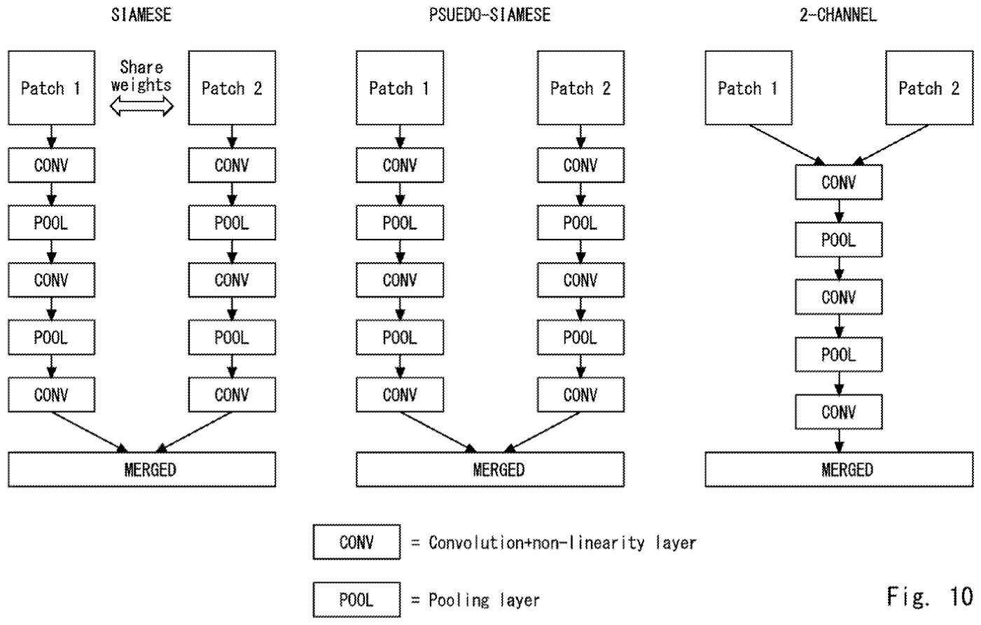

First, the training mode will be explained with reference to FIG. 2. A pair of multi-temporal images I₁ and I₂ are input to train the object-driven feature extractor units 10A and 11A, respectively. A general way to input an image is to first divide the image into patches overlappingly or non-overlappingly, and then input those patches into feature extractor units, respectively. The feature extractor unit may be a series of neural-network layers which automatically extract features from the input image patches through non-linear operations. Rectified Linear Units (ReLU) is one promising non-linear operation used in a neural-network based feature extractor. Since there are two feature extractor units as shown in FIG. 1 (one for each image), a few exemplary configurations of the feature extractor units are shown in FIG. 10. The one example of configurations is called a siamese network in which each feature extractor unit has same architecture and share same weights, which means the feature extractor units extract the features from the two patches using the same approach. This configuration is suitable if the input images are homogeneous, for example either both SAR images or both optical images. Another configuration example is called a pseudo-siamese network which is similar to the siamese network configuration except that the weights are not shared. This configuration is suitable if the input images are non-homogeneous, for example one is a SAR image while the other is an optical image. Still another configuration example is called 2-channel network in which the two input patches are considered as a two-channel input and directly fed into the network. The present disclosure is not limited to any one configuration and all the configurations are equally acceptable. Note that the network architecture shown in FIG. 10 is merely an example and the number and types of neural-network layers will depend on the object of interest. The object-driven feature extractor units 10A and 11A output feature vectors, f₁ and f₂, for each pair of input patches.

The feature merger unit 12 receives the input of the features vectors f₁ and f₂, and outputs a combined feature vector f_{c} for each pair of the input patches. A few examples to combine the features are explained next. One example is concatenation in which the feature vectors are concatenated to form a combined feature vector. Another example is differencing wherein the features vectors are subtracted element-wise and the obtained differential vector is the combined feature vector. Still another example is to compute an L1-distance between the feature vectors and the obtained distance vector is the combined feature vector. Still another example is to compute an element-wise dot product of the feature vectors and the obtained dot-product vector is the combined feature vector. Note that the present disclosure is not limited to the above examples and other methods of feature merging can also be used.

The change classifier unit 13A receives the input of the combined feature vector f_{c} for each pair of input patches and outputs a number in the range [0, 1] denoted as ŷ_{CD} which indicates the probability of belonging to a change or no-change class.

It is to be noted the present disclosure is not limited to binary change detection and the same method can be applied for multiple change detection by those skilled in the art. The change classifier unit 13A can be any kind of classifiers, including both neural-network based and non-neural-network based.

The object classifier unit 14 receives the input of the feature vector f₁ of each patch of image I₁ and outputs a number in the range [0, 1] denoted as ŷ_{O1} which indicates the probability of belonging to an object or no-object class. Simultaneously, the object classifier unit 15 receives the input of the feature vector f₂ of each patch of image I₂ and outputs a number in the range [0, 1] denoted as ŷ_{O2} which indicates the probability of belonging to an object or no-object class. The object classifier unit can be any kind of classifiers, including both neural-network based and non-neural-network based.

The multi-loss calculator unit 16 receives the input of the predicted classes (ŷ_{CD}, ŷ_{O1}, and ŷ_{O2}) and true classes (y_{CD}, y_{O1} and y_{O2}) from the databases, and outputs a loss function E. The loss function E is a weighted combination of two types of losses, change classification loss and object classification loss, and thus termed as a multi-loss function. The loss function E(y_{CD}, y_{O1}, y_{O2}, ŷ_{CD}, ŷ_{O1}, ŷ_{O2}) is given by EQ. 1 as,

E(y_{CD},y_{O1},y_{O2},ŷ_{CD},ŷ_{O1},ŷ_{O2})=w₁E₁(y_{CD},ŷ_{CD})+w₂E₂(y_{O1},ŷ_{O1},y_{O2},ŷ_{O2}) EQ. 1

where E₂(y_{CD}. ŷ_{CD}) is the change classification loss, E₂(y_{O1}, y_{O2}, ŷ_{O1}, ŷ_{O2}) is the object classification loss, w₁ is weight of the change classification loss and w₂ is weight of the object classification loss. In order to determine an optimal set of weights w₁ and w₂, a grid search or a random search method can be employed in which the weights are searched in a range from [0, 1]. For each possible set of values of w₁ and w₂, the loss function E is computed and the network is trained until convergence. Finally the set of values which give the least value of the loss function E is selected.

The change classification loss function E₁(y_{CD}, ŷ_{CD}) computes a classification error between the predicted change class and the true change class using a cross-entropy loss as given in EQ. 2.

$${E}_{1} ( {y}_{CD} , {\hat{y}}_{CD} ) = - \frac{1}{n} {\sum }_{i = 1}^{n} [ {y}_{{CD}_{i}} log {\hat{y}}_{{CD}_{i}} + ( 1 - {y}_{{CD}_{i}} ) log ( 1 - {\hat{y}}_{{CD}_{i}} ) ] \qquad EQ . 2$$

where n are the total number of training patch pairs, y_{CD}_{ᵢ}, is the true change class of the i^{th} training patch pair and ŷ_{CD}_{ᵢ} is the predicted change class of the i^{th} training patch pair.

Similarly, the object classification loss function E₂(y_{O1}, ŷ_{O1}, y_{O2}, ŷ_{O2}) computes a classification error between the predicted object class and true object class using a cross-entropy loss as given in EQ. 3.

$${E}_{2} ( {y}_{O 1} , {\hat{y}}_{O 1} , {y}_{O 2} , {\hat{y}}_{O 2} ) = - \frac{1}{n} ( {\sum }_{i = 1}^{n} [ {y}_{O {1}_{i}} log {\hat{y}}_{O {1}_{i}} + ( 1 - {y}_{O {1}_{i}} ) log ( 1 - {\hat{y}}_{O {1}_{i}} ) ] + {\sum }_{i = 1}^{n} [ {y}_{O {2}_{i}} log {\hat{y}}_{O {2}_{i}} + ( 1 - {y}_{O {2}_{i}} ) log ( 1 - {\hat{y}}_{O {2}_{i}} ) ] ) \qquad EQ . 3$$

where n are the total number of training patch pairs, y_{O1}_{ᵢ} is the true object class of the i^{th} training patch of image I₁, y_{O1} is the predicted object class of the i^{th} training patch of image I₂, y_{O2}_{ᵢ}, is the true object class of the i^{th} training patch of image I₂ and ŷ_{O2}_{ᵢ} is the predicted object class of the i^{th} training patch of image I₂.

Note that the cross-entropy loss is merely an exemplary loss and other loss functions such as Kullback-Leibler divergence, contrastive loss, hinge loss and mean-squared error can also be used to compute the classification errors.

The parameter updater unit 17 receives the loss E from the multi-loss calculator unit 16 and updates the parameters of the object-driven feature extractor units 10A and 11A so that the loss can be minimized. In the case that the change classifier unit 13A and the object classifier units 14 and 15 are neural-network based, the parameter updater unit 17 updates the parameters of the change classifier unit 13A and the object classifier units 14 and 15 also so that the loss can be minimized. The minimization of loss can be performed by an optimization algorithm such as gradient descent. The minimization of the loss is continued (or repeated) until the loss converges to a state in which it cannot be reduced further. At this stage, the loss has converged and the feature extraction unit 10A and 11A are trained. After convergence, the parameter updater unit 17 stores the parameters of the trained object-driven feature extractor units into the storage unit 18. The trained object-driven feature extraction units are denoted as 10B and 11B as shown in FIG. 4. In the case that the change classifier unit 13A is neural-network based, its parameters are also stored in the storage unit 18 after the loss has converged. The trained change classifier unit is denoted as 13B as shown in FIG. 4. In the case that the object classifier units 14 and 15 are neural-network based, their parameters are also stored in the storage unit 18 after the loss is converged.

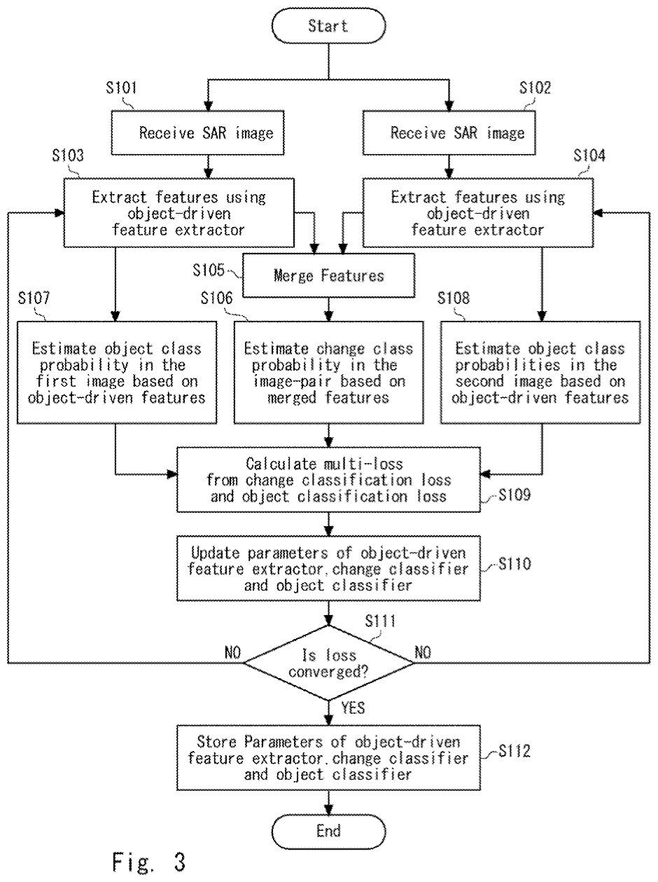

Next, an example of an operation performed by the image processing apparatus 1A according to the first embodiment in training mode will be explained with reference to a flowchart shown in FIG. 3.

Firstly, the image processing apparatus 1A receives the input of a pair of multi-temporal SAR images (steps S101 and S102). Next, the image processing apparatus 1A extracts features from the first SAR image using an object-driven feature extractor unit 10A (step S103). Simultaneously, the image processing apparatus 1A extracts object-driven features from the second SAR image using another feature extractor unit 11A (step S104). Next, the image processing apparatus 1A merges the features extracted by the two feature extractors units 10A and 11A using the feature merger unit 12 (step S105). Next, the image processing apparatus 1A estimates a change class probability in the image-pair based on the merged features using the change classifier unit 13A (step S106). Simultaneously, the image processing apparatus 1A estimates the object class probability in the first image based on the object-driven features of the first image using the object classifier unit 14 (step S107). Similarly, the image processing apparatus 1A estimates the object class probability in the second image based on the object-driven features of the second image using the object classifier unit 15 (step S108). Next, the image processing apparatus 1A calculates a multi-loss from a change classification loss and an object classification loss. Here, the change classification loss is calculated as a classification error between the true change class and the estimated change class and the object classification loss is calculated as a classification error between the true object class and the estimated object class using the multi-loss calculator unit 16 (step S109). Next, the image processing apparatus 1A updates the parameters of the feature extractor units 10A and 11A, change classifier unit 13A and object classifier units 14 and 15 using the parameter updater unit 17 so that the loss can be minimized (step S110). Next, the image processing apparatus 1A determines whether or not the loss has converged (step S111). When the image processing apparatus 1A determines that the loss has not converged yet (NO at step S111), the image processing apparatus 1A returns to the step S103 and the step S104. Then, the image processing apparatus 1A performs the step S103 and the step S104 again simultaneously. Then, the image processing apparatus 1A performs the processes in the steps S105 to S110 again. On the other hand, when the image processing apparatus 1A determines that the cost has converged (YES at step S111), the image processing apparatus 1A stores the trained feature extractor parameters, the trained change classifier parameters and the trained object classifier parameters into the storage unit 18 (step S112).

Next, the operational mode will be explained with reference to FIG. 4. In the operational mode, the trained object-driven feature extractor units 10B and 11B receives the input of a new pair of multi-temporal images (which has never been used in the training mode) and the parameters from the storage unit 18. Each trained feature extractor unit outputs robust and relevant feature vectors, f₁ and f₂, for each patch pair of the input images. The feature merger unit 12 combines the feature vectors and outputs a combined feature vector f_{c}. The trained change classifier unit 13B receives the input of the combined feature vector f_{c} and the parameters from the storage unit 18, and outputs a probability of belonging to a change or no-change class for the patch pair. The thresholder unit 19 receives the input of the probability value and automatically determines a threshold value. A few examples to automatically determine the threshold value may be Expectation-Maximization and Markov Random Field. If the probability value is more than the threshold value, pixels in the patch are assigned a change class, otherwise a no-change class. Finally the decisions of all the patches are combined to generate a change map in which each pixel belongs to either change or no-change class. Note that the present disclosure is not limited to only two change classes and can be used for multiple change classes. The change map can represent binary or multiple changes depending on the application.

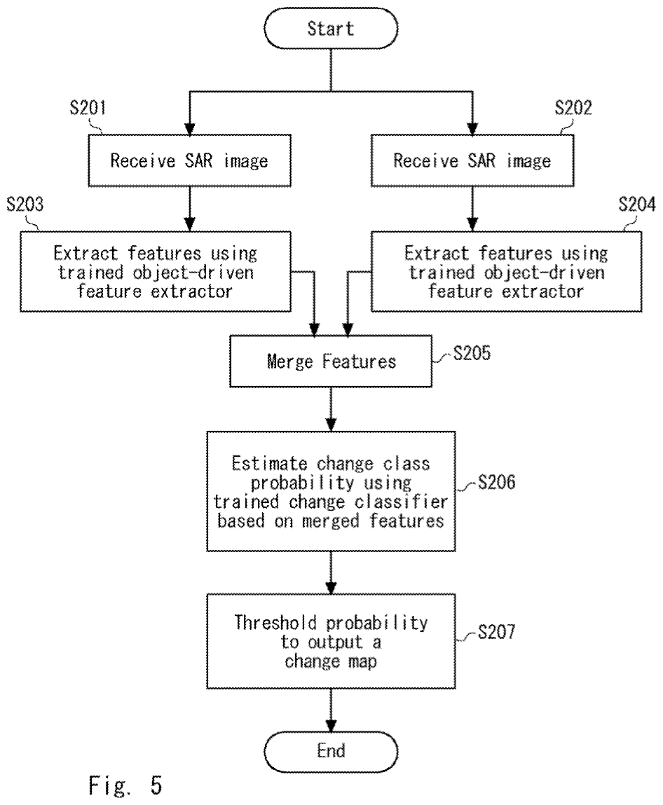

Next, an example of an operation performed by the image processing apparatus 1B according to the first embodiment in the operational mode will be explained with reference to a flowchart shown in FIG. 5.

Firstly, the image processing apparatus 1B receives the input of a new pair of multi-temporal SAR images (steps S201 and S202). Next, the image processing apparatus 1B extracts object-driven features from the first SAR image using the trained object-driven feature extractor unit 10B which reads the trained parameters from the storage unit 18 (step S203). Simultaneously, the image processing apparatus 1B extracts features from the second SAR images using the trained object-driven feature extractor unit 11B which reads the trained parameters from the storage unit 18 (step S204). Next, the image processing apparatus 1B merges the features extracted by the two trained feature extraction units 10B and 11B using the feature merger unit 12 (step S205). Next, the image processing apparatus 1B estimates the change class probability using trained change classifier unit 13B which reads the trained parameters from the storage unit 18 (step S206). Next, the image processing apparatus 1B thresholds the probability values using a thresholder unit 19 by automatically determining a threshold value to output a change map (step S207).

As described above, the image processing apparatus (1A and 1B) in accordance with the first embodiment of the present disclosure can consider change detection using the object-driven feature extraction units 10 and 11, the object classifier units 14 and 15, and the multi-loss calculator unit 16. Unlike the related art where the network learns only the single task of change detection, the present disclosure can learn two tasks simultaneously—the change detection task and the object classification task. The loss calculated using the multi-loss calculator unit 16 as a weighted combination of change classification loss and object classification loss focuses attention of the feature extraction units to learn features specific to the target object. As a result, the object-driven feature extraction units 10 and 11 can distinguish between the relevant and irrelevant features and a better change detection system is obtained.

### Second Embodiment

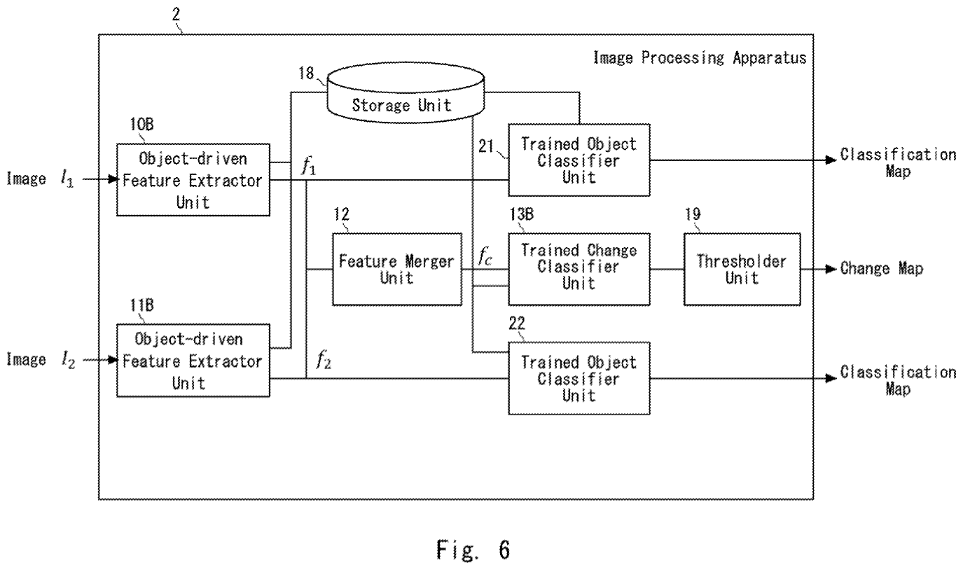

Next, a configuration example of an image processing apparatus 2 in accordance with the second embodiment of the present disclosure will be explained with reference to a block diagram shown in FIG. 6. The image processing apparatus 2 in accordance with the second embodiment can include a trained object-driven feature extractor unit 10B for image I₁, a trained object-driven feature extractor unit 11B for image I₂, a feature merger unit 12, a trained change classifier unit 13B, a trained object classifier unit 21 for image I₁, a trained object classifier unit 22 for image I₂, a storage unit 18 and a thresholder unit 19. Note that configurations of the trained object-driven feature extractor unit 10B for image I₁, the trained object-driven feature extractor unit 11B for image I₂, the feature merger unit 12, the trained change classifier unit 13B and the thresholder unit 19 are similar to those explained in the first embodiment of the present disclosure and therefore their explanations are omitted.

As compared to the first embodiment, the image processing apparatus 2 in accordance with the second embodiment can include a trained object classifier unit 21 for image I₁ and a trained object classifier unit 22 for image I₂.

As described in the first embodiment, in the operational mode a new pair of multi-temporal images (which has never been used for training) is input to the trained object-driven feature extraction units 10B and 11B in the form of patches. The trained object-driven feature extraction units 10B and 11B output robust and relevant features of the target object from each image respectively using the parameters from the storage unit 18. According to the second embodiment, the trained object classifier unit 21 receives the input of the feature vector f₁ of each patch of the image I₁ from the feature extractor unit 10B and parameters from the storage unit 18, and outputs a probability of belonging to an object or no-object class. Simultaneously, the trained object classifier unit 22 receives the input of the feature vector f₂ of each patch of the image I₂ from the feature extractor unit 10B and parameters from the storage unit 18, and outputs a probability of belonging to an object or a no-object class. The probability values of each patch can be either thresholded or used directly. The probability values of all the patches of an image are combined to output a classification map where each pixel belongs to either an object or a no-object class.

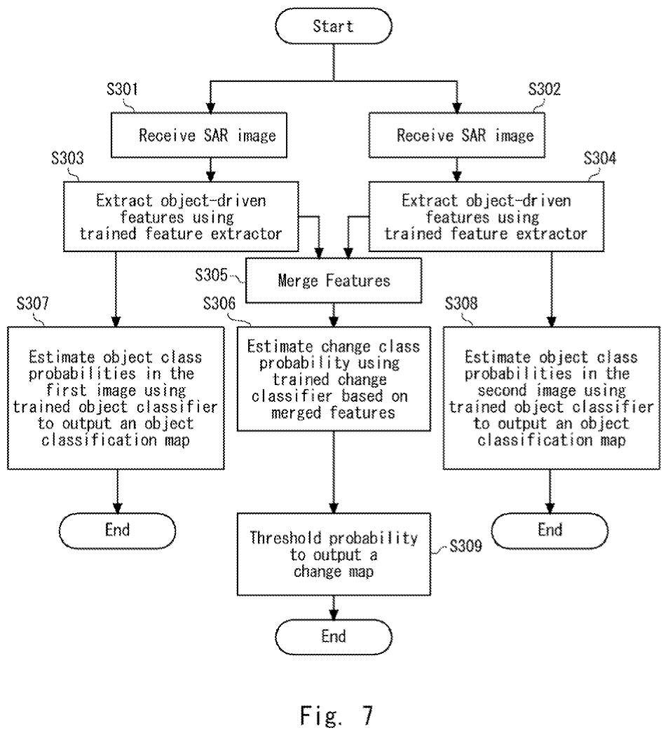

Next, an example of an operation performed by the image processing apparatus 2 according to the second embodiment will be explained with reference to a flowchart shown in FIG. 7. Note that steps S301, S302, S303, S304, S305, S306 and S309 in FIG. 7 are similar to the steps S201, S202, S203, S204, S205, S206 and S207 in FIG. 5, and therefore their explanations are omitted.

In addition to estimating change class probabilities as explained in the first embodiment, the image processing apparatus 2 in accordance with the second embodiment can also estimate the object class probabilities in the first image using the trained object classifier unit 21 which reads the trained parameters from the storage unit 18 (step S307). Simultaneously, the image processing apparatus 2 can estimate the object class probabilities in the second image using the trained object classifier unit 22 which reads the trained parameters from the storage unit 19 (step S308). The class probabilities can be either thresholded or used directly to output object classification maps of the respective images.

As described above, the image processing apparatus 2 in accordance with the second embodiment of the present disclosure can provide an additional output of classification map along with the change map. Since the features learnt by the object-driven feature extraction units can be optimized for multiple tasks of change detection and object classification, they are generic and can be used for object classification without re-training with additional data. Thus, the proposed disclosure can be extended to advanced analysis tasks such as object classification in SAR images.

### Third Embodiment

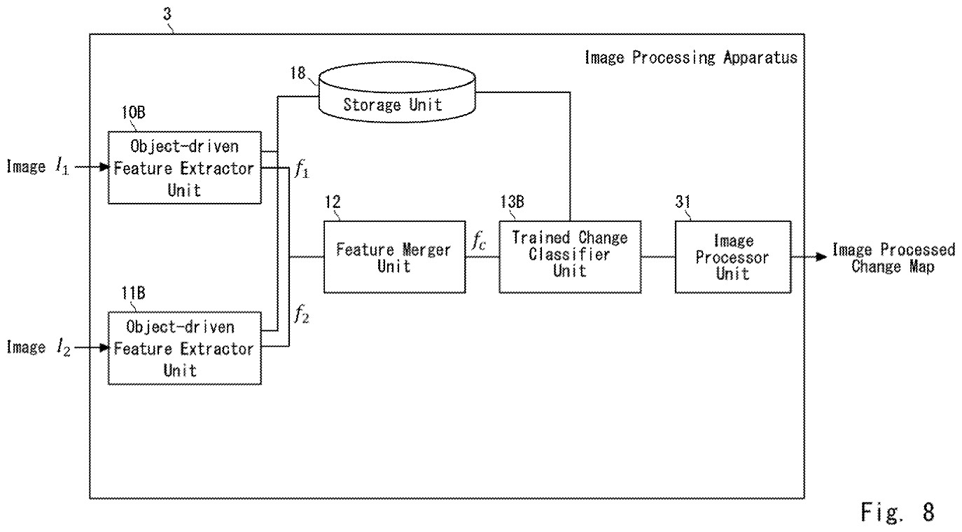

Next, a configuration example of an image processing apparatus 3 in accordance with the third embodiment of the present disclosure will be explained with reference to a block diagram shown in FIG. 8. The image processing apparatus 3 in accordance with the third embodiment can include a trained object-driven feature extractor unit 10B for image I₁, a trained object-driven feature extractor unit 11B for image I₂, a feature merger unit 12, a trained change classifier unit 13B, an image processor unit 31 and a storage unit 18. Note that configurations of the trained object-driven feature extractor unit 10B for image I₁, the trained object-driven feature extractor unit 11B for image I₂, the trained change classifier unit 13B and the storage unit 18 are similar to those explained in the first embodiment of the present disclosure and therefore their explanations are omitted.

As compared to the first embodiment, the image processing apparatus 3 in accordance with the third embodiment replaces the thresholder unit 19 with an image processor unit 31. The image processor unit 31 receives the input of the probability values from the trained change classifier unit 13B and outputs an image processed change map such as a density map, a distance map or a colorization map by applying an image processing operator on the probability values. The type of the map depends on the application of the change detection system.

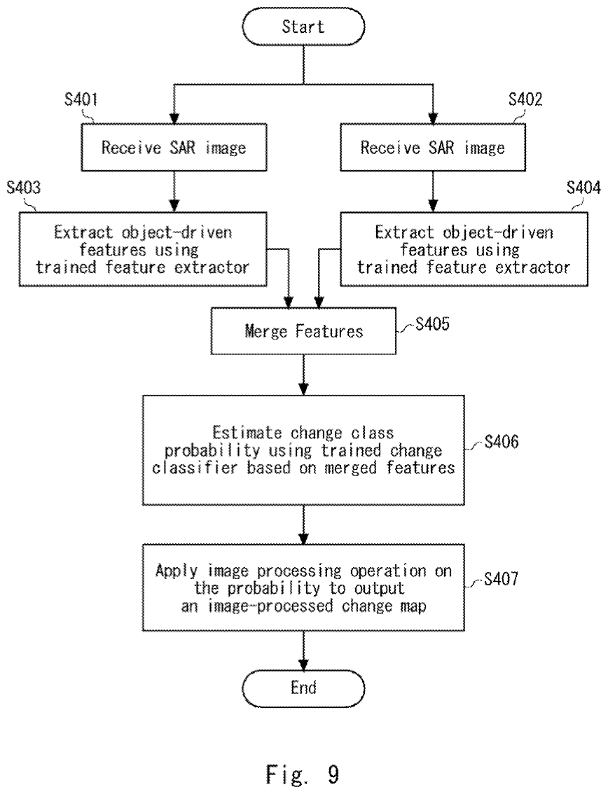

Next, an example of an operation performed by the image processing apparatus 3 according to the third embodiment will be explained with reference to a flowchart shown in FIG. 9. Note that steps S401, S402, S403, S404, S405 and S406 in FIG. 9 are similar to the steps S201, S202, S203, S204, S205 and S206 in FIG. 5, and therefore their explanations are omitted.

After obtaining the class probabilities from the trained change classifier unit 13B (step S406), the image processing apparatus 3 applies an image processing operation on the class probabilities such as a distance estimator or a density estimator using the image processor unit 31 to output an image processed change map (step S407).

As described above, the image processing apparatus 3 in accordance with the third embodiment of the present disclosure can provide different types of outputs using post-processing the probability values estimated by the trained change classifier unit 13B. These alternative outputs can provide additional information about the target object based on the application. For example, if the user wants to know the amount of changes instead of only detecting change and no-change, a density map can be output after the post-processing. The density map highlights the amount of changes in which a low density value implies a small change and high density value implies a large change. Thus, the change detection system can provide more detail about the changes of the target object and can be used for many applications.

Further, although the present disclosure is described as a hardware configuration in the above-described embodiments, the present disclosure is not limited to the hardware configurations. The present disclosure can be implemented by having a processor such as a CPU (Central Processing Unit) included in the image processing apparatus to execute a computer program for performing each process in each of the above-described functions.

In the above-described examples, the program can be stored in various types of non-transitory computer readable media and thereby supplied to computers. The non-transitory computer readable media includes various types of tangible storage media. Examples of the non-transitory computer readable media can include a magnetic recording medium (such as a flexible disk, a magnetic tape, and a hard disk drive), a magneto-optic recording medium (such as a magneto-optic disk), a CD-ROM (Read Only Memory), a CD-R, and a CD-R/W, a DVD (Digital Versatile Disc), a BD (Blu-ray (registered trademark) Disc), and a semiconductor memory (such as a mask ROM, a PROM (Programmable ROM), an EPROM (Erasable PROM), a flash ROM, and a RAM (Random Access Memory)). Further, the program can be supplied to computers by using various types of transitory computer readable media. Examples of the transitory computer readable media can include an electrical signal, an optical signal, and an electromagnetic wave. The transitory computer readable media can be used to supply programs to computer through a wire communication path such as an electrical wire and an optical fiber, or wireless communication path.

Although the present disclosure is explained above with reference to embodiments, the present disclosure is not limited to the above-described embodiments. Various modifications that can be understood by those skilled in the art can be made to the configuration and details of the present disclosure within the scope of the invention.

Part of or all the foregoing embodiments can be described as in the following appendixes, but the present invention is not limited thereto.

### (Supplementary Note 1)

An image processing apparatus for a training method of change detection comprising:

an object-driven feature extractor means to extract relevant features of target object from input images;

a feature merger means to merge the features extracted from the input images into a merged feature;

a change classifier means to predict a probability of each change class based on the merged feature;

an object classifier means to predict a probability of each object class based on the extracted features of each image;

a multi-loss calculator means to calculate a combined loss from a change classification loss and an object classification loss; and

a parameter updater means to update parameters of the object-driven feature extractor means.

### (Supplementary Note 2)

The image processing apparatus according to note 1, wherein the parameter updater means updates the parameters of the change classifier means and object classifier means.

### (Supplementary Note 3)

The image processing apparatus according to note 1 or note 2, wherein the multi-loss calculator means calculates a weighted combination of a change classification loss and an object classification loss.

### (Supplementary Note 4)

The image processing apparatus according to note 3, wherein the weights are determined using grid search or random search.

### (Supplementary Note 5)

The image processing apparatus according to any one of note 1 to note 4, wherein the change classification loss and object classification loss are selected from the group consisting of cross-entropy, Kullback-Leibler divergence, contrastive loss, hinge loss and mean-squared error as a loss function.

### (Supplementary Note 6)

The image processing apparatus according to any one of note 1 to note 5, wherein the input images are captured by Synthetic Aperture Radar.

### (Supplementary Note 7)

The image processing apparatus for change detection method comprising,

an object-driven feature extractor means to extract relevant features of target object from input images;

a feature merger means to merge the features extracted from the input images into a merged feature; and

a change classifier means to predict a probability of each change class based on the merged features,

wherein the object-driven feature extractor means and the change classifier means use parameters trained using the training method according to any one of note 1 to note 6.

### (Supplementary Note 8)

The image processing apparatus according to note 7, further comprising a thresholder means to threshold the predicted probability of each change class.

### (Supplementary Note 9)

The image processing apparatus according to note 7, further comprising an image processor means to apply an image processing operation on the predicted probability of each change class.

### (Supplementary Note 10)

The image processing apparatus according to note 9, wherein the image processor means is a kernel density estimator or a euclidean distance estimator.

### (Supplementary Note 11)

The image processing apparatus for change detection method according to any one of note 7 to note 10, further comprising:

an object classifier means to predict a probability of each object class based on the extracted features of each image,

wherein the object classifier means uses parameters trained using the training method according to any one of note 1 to note 6.

### (Supplementary Note 12)

The image processing apparatus according to any one of note 1 to note 11, wherein the object-driven feature extraction means use a neural-network based method.

### (Supplementary Note 13)

The image processing apparatus according to note 12 wherein the neural-network based method is a siamese network, pseudo-siamese network or 2-channel network.

### (Supplementary Note 14)

The image processing apparatus according to any one of note 1 to note 11, wherein the change classifier means uses a Decision Tree, Support Vector Machine, Neural Network, Gradient Boosting Machine, or an ensemble thereof.

### (Supplementary Note 15)

The image processing apparatus according to any one of note 1 to note 11, wherein the object classifier means is a Decision Tree, Support Vector Machine, Neural Network, Gradient Boosting Machine, or an ensemble thereof.

### (Supplementary Note 16)

The image processing apparatus according to any one of note 1 to note 11, wherein the feature merger means combines features by concatenation, absolute subtraction, mean-squared subtraction or dot-product, or a combination thereof.

### (Supplementary Note 17)

An image processing method comprising:

extracting object-driven features of target object from input images;

merging the features extracted from the input images into a merged feature;

predicting a probability of each change class based on the merged feature;

predicting a probability of each object class based on the extracted features of each image;

calculating a combined loss from a change classification loss and an object classification loss; and

updating parameters for extracting the object-driven feature.

### (Supplementary Note 18)

A non-transitory computer readable medium storing an image processing program is a non-transitory computer readable medium storing an image processing program for causing a computer to execute an image processing method, an image processing method comprising:

extracting object-driven features of target object from input images;

merging the features extracted from the input images into a merged feature,

predicting a probability of each change class based on the merged feature;

predicting a probability of each object class based on the extracted features of each image;

calculating a combined loss from a change classification loss and an object classification loss; and

updating parameters for extracting the object-driven feature.

### REFERENCE SIGNS LIST

1A, 1B, 2, 3 Image Processing Apparatus
10, 11 Object-driven Feature Extraction Units
12 Feature Merger Unit
13A Change Classifier Unit
13B Trained Change Classifier Unit
14, 15 Object Classifier Units
16 Multi-loss Calculator Unit
17 Parameter Updater Unit
18 Storage Unit
19 Thresholder Unit
21, 22 Trained Object Classifier Units
31 Image Processor Unit

What is claimed is:

1. An image processing apparatus for a training method of change detection comprising:
an object-driven feature extractor configured to extract relevant features of target object from input images;
a feature merger configured to merge the features extracted from the input images into a merged feature;
a change classifier configured to predict a probability of each change class based on the merged feature;
an object classifier configured to predict a probability of each object class based on the extracted features of each image;
a multi-loss calculator configured to calculate a combined loss from change classification loss and object classification loss; and
a parameter updater configured to update parameters of the object-driven feature extractor.

2. The image processing apparatus according to claim 1, wherein the parameter updater updates the parameters of the change classifier and object classifier.

3. The image processing apparatus according to claim 1, wherein the multi-loss calculator calculates a weighted combination of change classification loss and object classification loss.

4. The image processing apparatus according to claim 3, wherein the weights of the change classification loss and object classification loss are determined using a grid search or random search.

5. The image processing apparatus according to claim 1, wherein the change classification loss and object classification loss are selected, as a loss function, from the group consisting of cross-entropy, Kullback-Leibler divergence, contrastive loss, hinge loss and mean-squared error.

6. The image processing apparatus according to claim 1, wherein the input images are captured by Synthetic Aperture Radar.

7. The image processing apparatus for change detection method comprising,
an object-driven feature extractor configured to extract relevant features of target object from input images;
a feature merger configured to merge the features extracted from the input images into a merged feature; and
a change classifier configured to predict a probability of each change class based on the merged features;
wherein the object-driven feature extractor and the change classifier use parameters trained using the training method according to claim 1.

8. The image processing apparatus according to claim 7, further comprising a thresholder configured to threshold the predicted probability of each change class.

9. The image processing apparatus according to claim 7, further comprising an image processor configured to apply an image processing operation on the predicted probability of each change class.

10. The image processing apparatus according to claim 9, wherein the image processor is a kernel density estimator or a euclidean distance estimator.

11. The image processing apparatus for change detection method comprising,
an object-driven feature extractor configured to extract relevant features of target object from input images;
a feature merger configured to merge the features extracted from the input images into a merged feature; and
a change classifier configured to predict a probability of each change class based on the merged features;
wherein the object-driven feature extractor and the change classifier use parameters trained using the training method according to claim 1,
and, further comprising:
an object classifier configured to predict a probability of each object class based on the extracted features of each image,
wherein the object classifier uses parameters trained using the training method.

12. The image processing apparatus according to claim 1, wherein the object-driven feature extraction means a neural-network based method.

13. The image processing apparatus according to claim 12 wherein the neural-network based method is a siamese network, pseudo-siamese network or 2-channel network.

14. The image processing apparatus according to claim 1, wherein the change classifier uses a Decision Tree, Support Vector Machine, Neural Network, Gradient Boosting Machine, or an ensemble thereof.

15. The image processing apparatus according to claim 1, wherein the object classifier is a Decision Tree, Support Vector Machine, Neural Network, Gradient Boosting Machine, or an ensemble thereof.

16. The image processing apparatus according to claim 1, wherein the feature merger combines features by concatenation, absolute subtraction, mean-squared subtraction or dot-product, or a combination thereof.

17. An image processing method comprising:
extracting object-driven features of target object from input images;
merging the features extracted from the input images into a merged feature;
predicting a probability of each change class based on the merged feature;
predicting a probability of each object class based on the extracted features of each image;
calculating a combined loss from change classification loss and object classification loss; and
updating parameters for extracting the object-driven feature.

18. A non-transitory computer readable medium storing an image processing program, the image processing program for causing a computer to execute an image processing method, the image processing method comprising:
extracting object-driven features of target object from input images;
merging the features extracted from the input images into a merged feature,
predicting a probability of each change class based on the merged feature;
predicting a probability of each object class based on the extracted features of each image;
calculating a combined loss from a change classification loss and an object classification loss; and
updating parameters for extracting the object-driven feature.
